(19) United States
(12) Patent Application Publication
(10) Pub. No.: US 2012/0185386 A1
(43) Pub. Date: Jul. 19, 2012

(54) AUTHENTICATION TOOL

(75) Inventors: Hisham Ibrahim Salama, Charlotte, NC (US); David Shroyer, Matthews, NC (US); Darrell Fitzgerald Stanfield, York, SC (US); Denise Hanna Beachley, Huntersville, NC (US); Phillip Wayne Dunne, Auburn, CA (US); Murali K. Bolisetty, Bellevue, WA (US)

(73) Assignee: BANK OF AMERICA, Charlotte, NC (US)

(21) Appl. No.: 13/008,281

(22) Filed: Jan. 18, 2011

(51) Int. Cl. G06Q 40/00

(52) U.S. Cl. 705/42

(57) ABSTRACT

An electronic funds transfer authentication system and method facilitates the verification and authentication of a user and if authenticated allows the user to perform an action in an online system, such as an electronic funds transfer. The user-entered data is validated, and then the action (e.g., electronic funds transfer) is validated using credit/debit card information. Using a unique combination of security measures and procedures, the risk associated with various types of action and fund transfers is reduced, thereby enabling a financial institution to protect its customers' accounts with a greater degree of certainty.

### FIELD

Embodiments of the present invention relate to an authentication tool and more particularly to methods and systems for authenticating a user so that the user can perform an action in an online banking system.

### BACKGROUND

There are many different types of transfer systems available today that allow a customer to electronically transfer funds from one account to another. For example, a customer may transfer funds from an account by initiating an Automated Clearing House (“ACH”) transaction on an ACH platform, or she can transfer funds by means of a wire transfer using another platform. One concern, however, is whether the user accessing the transfer system is, in fact, the owner (or authorized user) of the source account from which the funds are being transferred. In order to avoid fraudulent transfers, it is important to verify the owner of the source account. Making this determination may be made difficult depending on the transfer system being used. To address this concern, various security measures are taken by financial institutions to detect and prevent fraudulent transactions. However, these security measures may slow down or restrict the fast, real-time movement of funds from one account to another.

There is currently no authentication system that will expeditiously provide a high level of certainty regarding the user's ownership of the source account to facilitate the expeditious movement of funds between accounts, much less an authentication system that will facilitate the integration of various transfer systems where the ownership of an account may be more difficult to ascertain, thereby enabling a customer to easily transfer funds from one account to another using a variety of transfer methods accessible through one simplified online interface.

### SUMMARY

Embodiments of the present invention address the above issues and relate to an authentication systems, computer program products and methods to facilitate the verification and authentication of a user and, if authenticated, allow the user to perform an action in an online system, such as an electronic funds transfer. The authentication tool prompts the user to input credit/debit card information when initiating an action in the online banking system, such as electronic funds transfer. The inputted credit/debit card information is then sent to a server and utilized to authenticate the user. If authenticated, the user is allowed to perform the selected online banking action; otherwise, the user is not allowed to perform such task. Using a unique combination of security procedures, the risk associated with various types of action and fund transfers is reduced through the present invention, thereby enabling a financial institution to protect its customers' accounts with a greater degree of certainty.

In some exemplary embodiments, the present invention relates to a method of authenticating an electronic funds transfer. The method includes receiving logon credentials of a user to an online banking system of a financial institution where the user has an account and authenticating the user to the online banking system. A selection that the user desires to perform an electronic funds transfer using the user's account is received. Presented is an authentication tool configured to allow a user to enter information associated with a credit/debit card that is in turn associated with the user's account to determine if the user is authorized to perform the electronic funds transfer. Credit/debit card information entered by the user into the authentication tool is received by an identification of the user is validated using the received credit card information and the user is authenticated in response to the identification of the user being valid.

In some other exemplary embodiments of the invention, a method of authenticating an action in an online banking system is disclosed. The method includes receiving logon credentials of a user to the online banking system of a financial institution where the user has an account and authenticating the user to the online banking system. A selection of an action that the user desires to perform in the online banking system is received. Presented is an authentication tool configured to allow a user to enter credit card information of a credit/debit card associated with the user's account to determine if the user is authorized to perform the selected action. Credit card information entered by the user into the authentication tool is received, and the user is authenticated in response to the received credit card information being validated.

In some other exemplary embodiments of the invention, a non-transitory computer-readable medium is disclosed. The computer readable medium has computer program code embodied thereon, the computer program code, when executed on a computing device, is configured to perform a method for authenticating an action via an online banking system. The method includes receiving logon credentials of a user to an online banking system of a financial institution where the user has an account and authenticating the user to the online banking system. A selection that the user desires to perform an electronic funds transfer using the user's account is received. Presented is an authentication tool configured to allow a user to enter via the online banking system information associated with a credit/debit card that is in turn associated with the user's account to determine if the user is authorized to perform the electronic funds transfer. Credit card information entered by the user into the authentication tool is received. An identification of the user is validated using the received credit card information and the user is authenticated in response to the identification of the user being valid.

In some other exemplary embodiments of the invention, an apparatus for authenticating an action via an online system is disclosed. The apparatus includes an input system configured to allow a user to log into the online system and initiate the action via the online system; and a processing system in communication with the input system. The processing system is configured to receive credit card information entered by the user into the authentication tool; and authenticate the user in response to the received credit card information being validated.

In some other exemplary embodiments of the invention, another method of authenticating an action in an online banking system is disclosed. The method includes receiving logon credentials of a user to the online banking system of a financial institution where the user has an account and authenticating the user to the online banking system. The method further includes receiving a selection of an action that the user desires to perform in the online banking system. The method yet further includes determining if the user is enrolled in an authentication program, whereby the authentication program comprises a first authentication tool in response to the user attempting to perform an action in an online banking system. In response to determining that the user is enrolled in the authentication program, the first authentication tool is presented; in response to determining that the user is not enrolled in the authentication program a second authentication tool that is different from the first authentication tool is presented. The second authentication tool is configured to allow a user to enter via the online banking system information associated with a credit/debit card that is in turn associated with the user's account to determine if the user is authorized to perform the electronic funds transfer. The method yet further includes determining, using a computer, if the user is authenticated using input received in the first authentication tool or the second authentication tool.

In some other exemplary embodiments of the invention, an apparatus for authenticating an action via an online system is disclosed. The apparatus includes an input system configured to allow a user to log into the online system and initiate the action via the online system; and a processing system in communication with the input system. The processing system is configured to determine if the user is enrolled in an authentication program. In response to the user attempting to perform an action in an online banking system, the processing system is configured to: present a first authentication tool in response to determining that the user is enrolled in the authentication program; and present a second authentication tool that is different from the first authentication tool in response to determining that the user is not enrolled in the authentication program, wherein the second authentication tool is configured to allow a user to enter via the online banking system information associated with a credit/debit card that is in turn associated with the user's account to determine if the user is authorized to perform the electronic funds transfer. The processing system is further configured to determine if the user is authenticated the user using input received in the first authentication tool or the second authentication tool; and allow the user to perform the action in response to the user being authenticated.

Other aspects and features of the present invention, as defined by the claims, will become apparent to those skilled in the art upon review of the following non-limited detailed description of the invention in conjunction with the accompanying figures.

### BRIEF DESCRIPTION OF THE DRAWINGS

FIG. 1 is a system block diagram of one embodiment of the electronic funds transfer authentication system.

FIGS. 2 and 3 are flowchart diagrams illustrating various embodiments of an authentication process.

FIG. 4 is an exemplary embodiment of an authentication tool.

FIGS. 5-7 are exemplary embodiments of the authentication tool of FIG. 4 used with an interface to perform an online action.

FIG. 8 is an exemplary embodiment of the authentication tool of SAFEPASS® in accordance with some embodiments.

### DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Like numbers refer to like elements throughout.

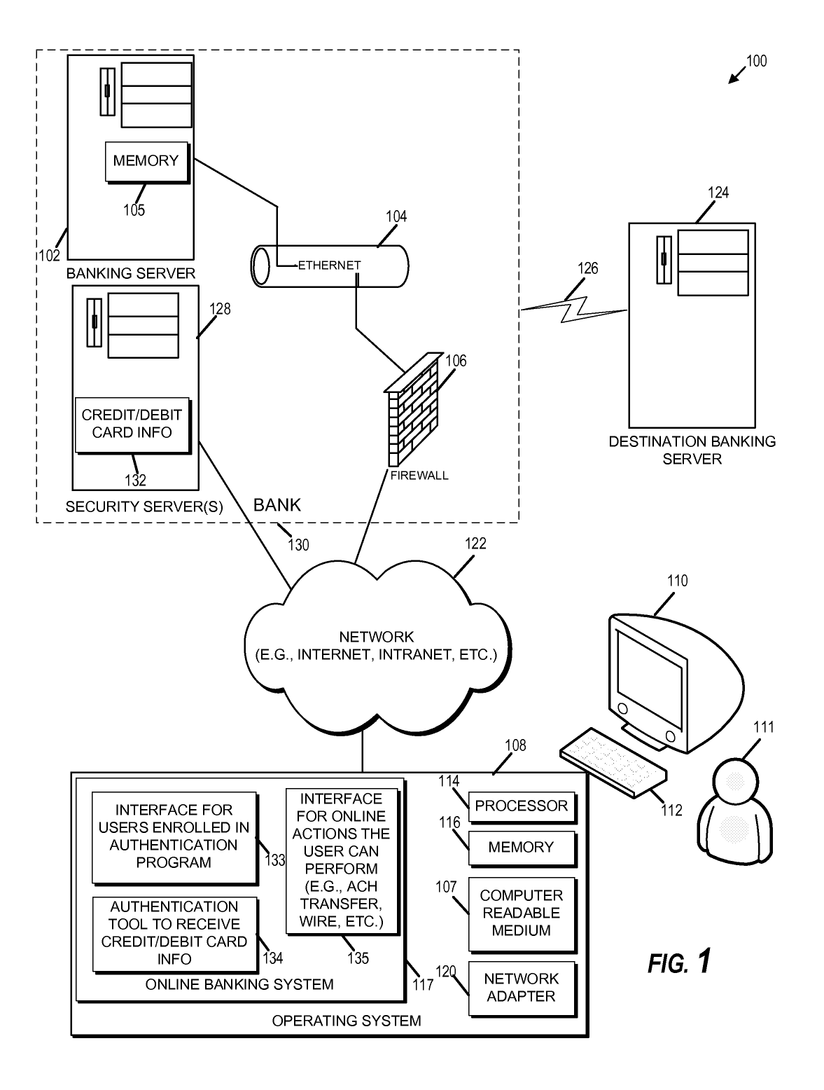

FIG. 1 illustrates a system block diagram of one embodiment of the authentication system 100. Banking server 102 is an online financial transaction server. The banking server 102 carries out the task of presenting the user interface to customers, gathering customer input for a funds transfer, implementing security measures and procedures, and processing the funds transfer. The banking server 102 may be referred to in this embodiment as the “processing system” of the invention. The banking server 102 is connected to any of the computing or hardware components of FIG. 1 via an Ethernet local area network (“LAN”) 104. As is the case with most businesses, these resources are located behind an Internet firewall 106. Computer program instructions to implement the various functions of the invention reside partly in the memory 105 of banking server 102 when the system 100 is in operation. When the system 100 is not in operation, the computer program instructions may reside on a computer readable medium 107, which may be a non-transitory computer readable medium or a transitory computer readable medium. The non-transitory computer readable medium may be a fixed medium, such as a fixed magnetic disk, or a portable non-transitory computer readable medium, such as a CD-ROM, flash memory drive, removable magnetic disk, and the like. The computer program instructions may alternatively reside or be communicated (e.g., downloaded, streamed, etc.) on a transitory computer readable medium, such as via an electrical wire/cable (for wired downloads/streaming), air (for a wireless downloads/streaming) or some other transitory medium.

A computer system 108 is represented in FIG. 1 by a conceptual block diagram. Such a computer system is typically connected to peripherals such as a display 110 and a keyboard 112. The processing platform includes one or more processors 114, a certain amount of memory 116 and a non-transitory computer readable medium 118. The computer system 108 accesses the bank's servers via the Internet 122 using a network adapter 120. When the computer system 108 is operating, computer program instructions, such as the operating system, are partially loaded into memory 116 and are executed by a CPU processor 114. The keyboard 112 receives user input and may be referred to herein as the “input system” of the computer system 108.

It should be noted that the computer system 108 of FIG. 1 is meant as an example only. Numerous types of general-purpose computer systems, special-purpose computer systems and other similar devices can be used, such as any computer connected to the Internet (e.g., the user's home computer or mobile laptop), an ATM owned by the user's bank/financial institution, a computer operated by a third party, a terminal connected to a network (e.g., intranet, Internet, etc.) at the bank, a mobile phone connectable to Wifi or a wide area network (“WAN”) or any other computing device. Available systems may include those that run operating systems such as Windows™ by Microsoft, various versions of UNIX™, various versions of LINUX™, various versions of Apple's MAC™ OS, Google's ANDROID™ and the like.

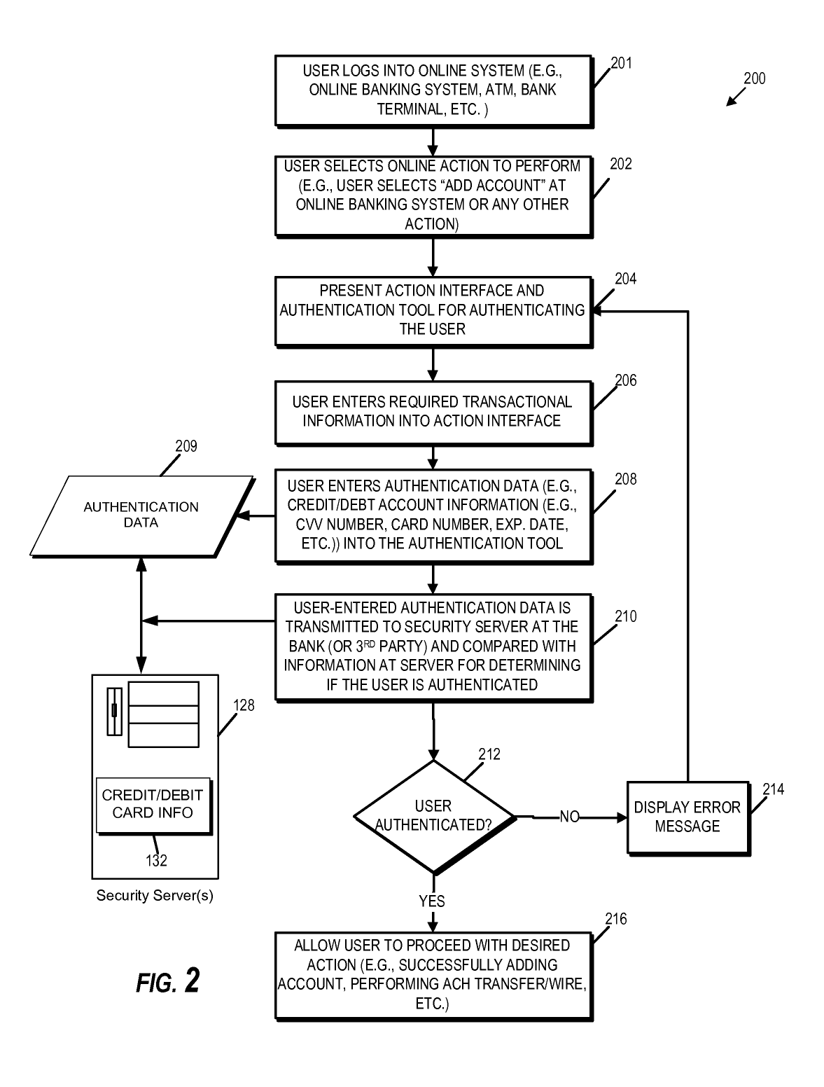

A user 111 enters input into the computer system 108 using the keyboard 112 and/or other input devices. The input is processed and communicated to banking server 102 via the Internet 122 using a web-based interface, such as an online banking system 117. Via the online banking system 117, the user is presented an interface 135 to perform one or more actions, such as electronic funds transfer (e.g., ACH transfer, wire, configuring direct deposits, etc.) and any other action that can be performed using the online banking system. As will be discussed later with regard to FIGS. 2-7, one or more interfaces 133-134 are presented to the user for the user to input information which will allow the authentication system 100 to authenticate the user. In one exemplary embodiment of the invention, the input includes transactional data related to a source account, a destination account, an amount of funds, and a transfer date. The source and destination accounts may be checking accounts, savings accounts, money market accounts, investment accounts, or other similar types of accounts. The input is received and processed by the banking server 102 in order to initiate an electronic transfer of funds from the source account to the destination account. The amount of funds input by the user may be transferred from the source account to the destination account using any number of electronic transfer methods, such as a wire transfer or an ACH transaction. Typically, a user would have to access multiple platforms in order to transfer funds using various electronic transfer methods; however, U.S. patent application Ser. No. 12/260,161, which is incorporated herein by reference, discloses an integrated electronic funds transfer system that enables a user to transfer funds from one account to another using one or more electronic transfer methods through one simplified interface.

After the electronic transfer method is determined, an electronic funds transfer 126 is initiated with a destination banking server 124, and the amount of funds is transferred from the source account to the destination account on the transfer date. The banking server 102 has the ability to access and deduct, or cause another computer system to access and deduct the amount of funds from the source account, which may be at the bank or another institution. Similarly, the destination banking server 124 has the ability to access and deposit, or cause another computer system to access and deposit, the amount of funds into the destination account, which may be at the destination bank or another institution. It should be noted that the destination banking server 124 and the banking server 102 are illustrated as being located at separate banks; however, it should be understood that the destination banking server 124 and the banking server 102 can be located at the same bank or located at separate banks such that a user can transfer funds between two banks or between a single bank.

As discussed previously, security measures are necessary to determine with a greater level of certainty that the user accessing banking server 102 through computer system 108 is the owner of the source account from which the funds are being transferred. These security measures are also necessary to facilitate the bank's detection and prevention of fraudulent transactions. In this embodiment of the invention, various security, authentication, and verification methods and procedures, which are described below in connection with FIGS. 2-8, are used in connection with a funds transfer to help reduce the risk associated with such transactions and to detect and prevent fraud. In some embodiments of the present invention, computer program instructions that reside partly in the memory 105 of the banking server 102 are used to implement these methods and procedures. Banking server 102 may utilize one or more security server(s) 128 to access and retrieve information regarding the user's account for authentication purposes, such as credit/debit card information 132 stored on the security server(s) 128 at the bank 130. It should be noted that the credit/debit card information 132 may be stored on a computer other than the security server 130, such as the banking server 105 or other server (not shown). Some or all of the security, authentication, and verification methods and procedures may also be implemented on security server(s) 128. Banking server 102 may access security server 128 via the Internet 122. Alternatively, security server 128 may be connected to the Ethernet LAN 104 for direct access by banking server 102. The security server 128 may be owned and operated by the bank 130, or the bank 130 may use the services and/or resources of an outside vendor (not shown) such that the security server 128 is located at a company (not shown) separate from the bank 130.

Multiple servers may be employed by the bank to implement various aspects of the invention. Therefore, the present invention is not limited to the specific embodiments of the electronic funds transfer authentication system 100 described herein. Banking server 102, destination banking server 124, and security server(s) 128 are each shown in this example as being implemented on a single hardware platform; however, one or more or all of these could just as easily be implemented on separate or multiple hardware platforms.

Additionally, while security server 128 is illustrated by a single computing device in FIG. 1, it should be understood that security server 128 could be a plurality of security servers, each of which could perform one or more steps of the present invention. However, for ease of illustration and description, the present invention is illustrated in FIG. 1 as a single security server 128.

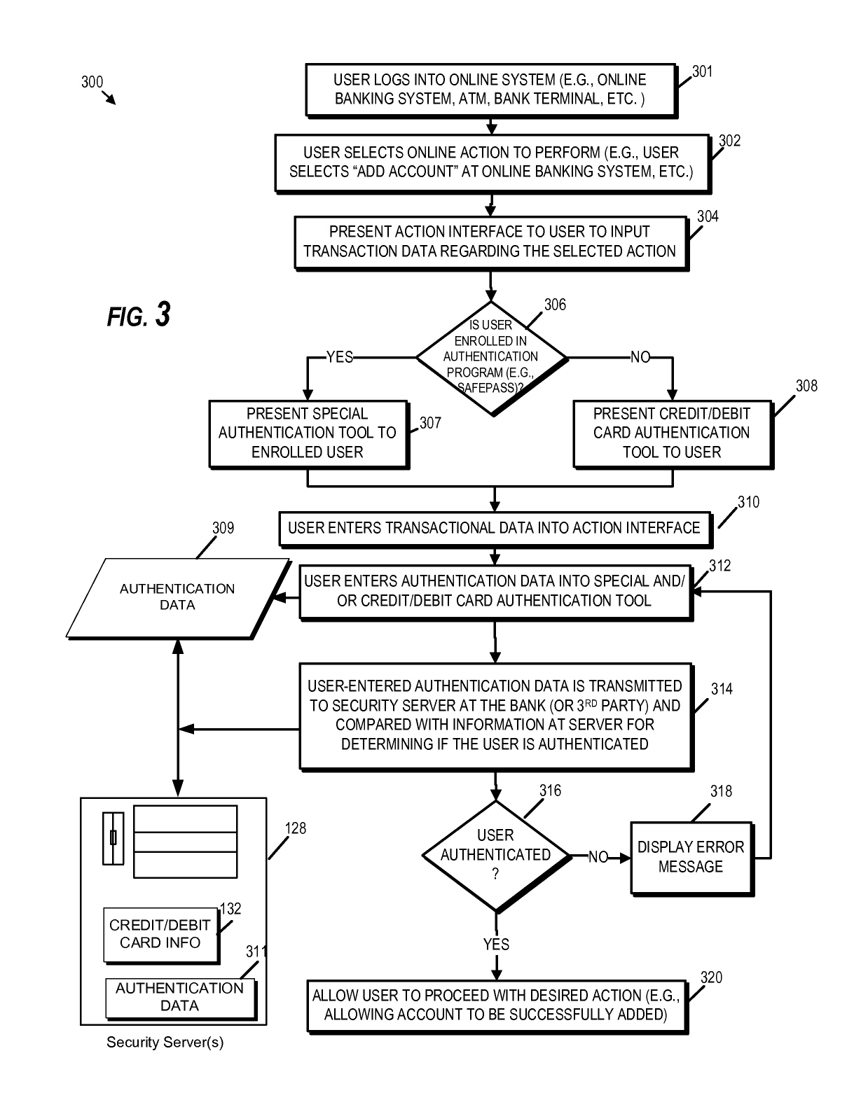

FIGS. 2 and 3 are flowchart diagrams illustrating one embodiment of the authentication process for performing the present invention. The process begins in FIG. 2 at block 201 when the user logs into the online system 117. Device recognition in the form of cookies, flash shared objects, and basic device forensics may be used to determine if the user's computer is one that the bank has authenticated before to access the online banking system. If the device is not recognized or there is an added measure of risk on the device, the user may be prompted to respond to one or more challenge questions or to enter a one-time passcode in order to authenticate the device. A device fingerprint may be used to uniquely identify a computing device. Each computing device that connects to a network has a variety of parameters that can be captured and analyzed. The large number of different possible parameter combinations lead to the uniqueness of individual device fingerprints. The device fingerprint is a score that is created and is based on the uniqueness of the device as derived from an evaluation of various device parameters.

If the user's computer has not been authenticated using the above steps, the user is prompted to enter a login credentials (e.g., user ID and password) to access an online banking system such as an electronic funds transfer system. If the user's credentials are valid, the user is logged into the online banking system where the user can access the user's account(s).

After the user is logged into the online banking system, the user selects an online action to perform at block 202. As used herein, the present invention is discussed with reference to the selected action being an electronic funds transfer. However, it should be understood that the user can perform other actions in the online system, such as opening a new account online (e.g., checking account, savings account, credit account, etc.), online banking enrollment, view accounts/account activity, managing and/or setting up bill pay, password changes, setting up direct deposit, or any other action that can be performed online. To initiate an electronic funds transfer, the user can select “add account” from a “Transfers” tab of the online banking system.

Because of the high-risk nature of wire transfers, additional security procedures may be used to validate a wire transfer using wire payment analytics, and the wire payment analytics may include, among other things, using a fraud detection engine to analyze the origination and destination information along with other wire specific information, or comparing the wire transfer to a negative file that may contain information related to various fraudulent transactions and/or activities.

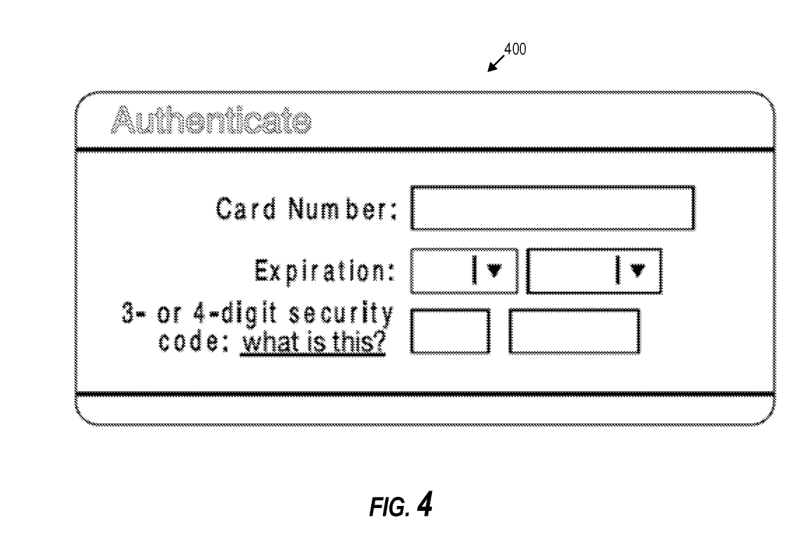

In block 204, an action interface and an authentication tool is presented to the user. The authentication tool is additional authentication procedure that may be used to authorize certain high-risk transactions when using an online banking system, such as, for example, transactions over a predetermined dollar amount. The authentication tool prompts the user to input authentication data about the user and/or a user's existing account with the bank, such as credit/debit card information. An example of the authentication tool 400 is illustrated in FIG. 4. As illustrated, the authentication tool of FIG. 4 prompts the user for the user's credit/debit card information, including the credit/debit card number, the expiration date of the credit/debit card, and the card verification value (“CVV”) of the credit/debit card. The CVV is a 3- or 4-digit security code typically presented on the back (or front) of a credit/debit card. The CVV is separate from the credit/debit card number and is only used for card verification/security purposes. It should be understood that the authentication tool 400 may prompt the user to input information other than or additional to the credit/debit card information, such as the user ID/password combination, a special security code electronically transmitted to the user, the user's account number (if different from the credit/debit card number), other information about the user (e.g., user's telephone number, user's name, user's demographics, etc.), and any other information that the bank can use to authenticate the user.

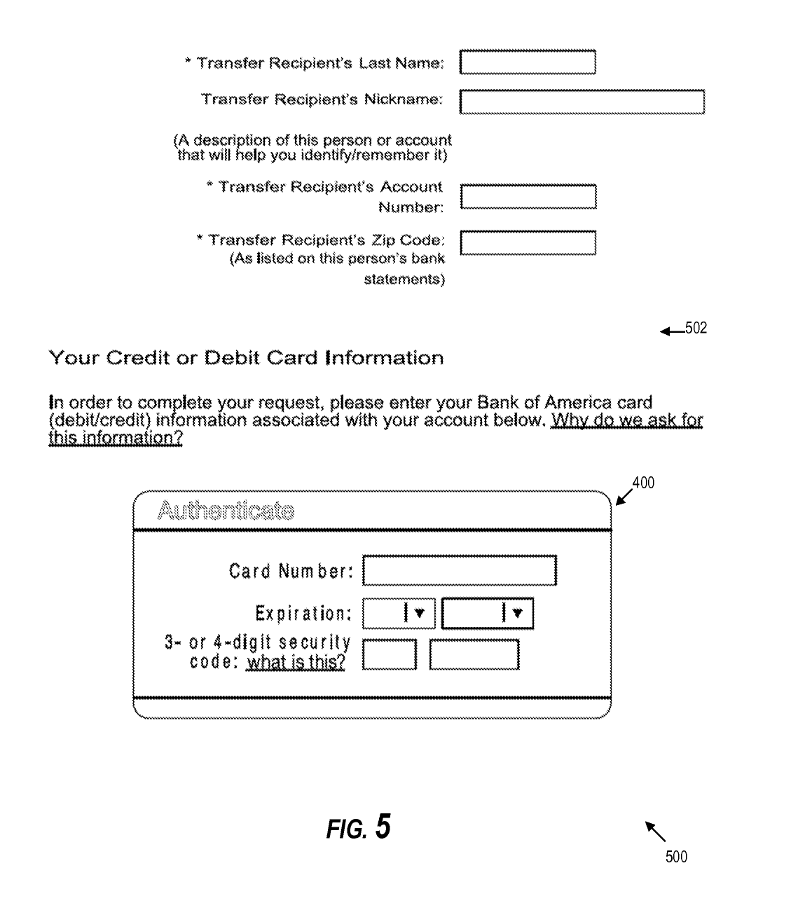

Referring back to FIG. 2 and as mentioned above, an action interface is also presented to the user in block 204. As used herein, the action interface is an interface presented to the user in response to the action selected by the user to perform and includes fields for entering transaction data required for performing the selected action, according to some embodiments. In the example of the action being an electronic funds transfer used herein, the transaction data may include, among other things, information regarding the source account, destination account, account holder(s), amount of funds to be transferred, the date upon which the funds are to be transferred from the source account to the destination account, and any other information that may be input for an electronic funds transfer. The action interface may also include instructions on inputting the transaction data, security information and/or any other information. Examples of action interfaces are illustrated in FIGS. 5-7 at reference numerals 502, 602 and 702, which are each discussed below.

As illustrated in FIG. 5, the action interface 502 is being presented in response to the user indicating a desire to perform an electronic funds transfer (and/or add an account that will allow the user to perform such transfer). The action interface 502 includes the text and input fields illustrated in FIG. 5 above the authentication tool 400 and prompts the user to input the transaction data, including the transfer recipient's last name, transfer recipient's nickname, transfer recipient's account number, and the transfer recipient's zip code. It should be noted that the transfer recipient's last name, transfer recipient's account number, and the transfer recipient's zip code are required input fields while the transfer recipient's nickname is an optional field. The transactional data requested in the action interface 502 is to be used in setting up, initiating or completing the electronic funds transfer. It should be noted that the user can also be prompted for other transactional data to set up the electronic funds transfer, such as the transfer recipient's address, the transfer recipient's bank, what type of account the recipient has, and the like.

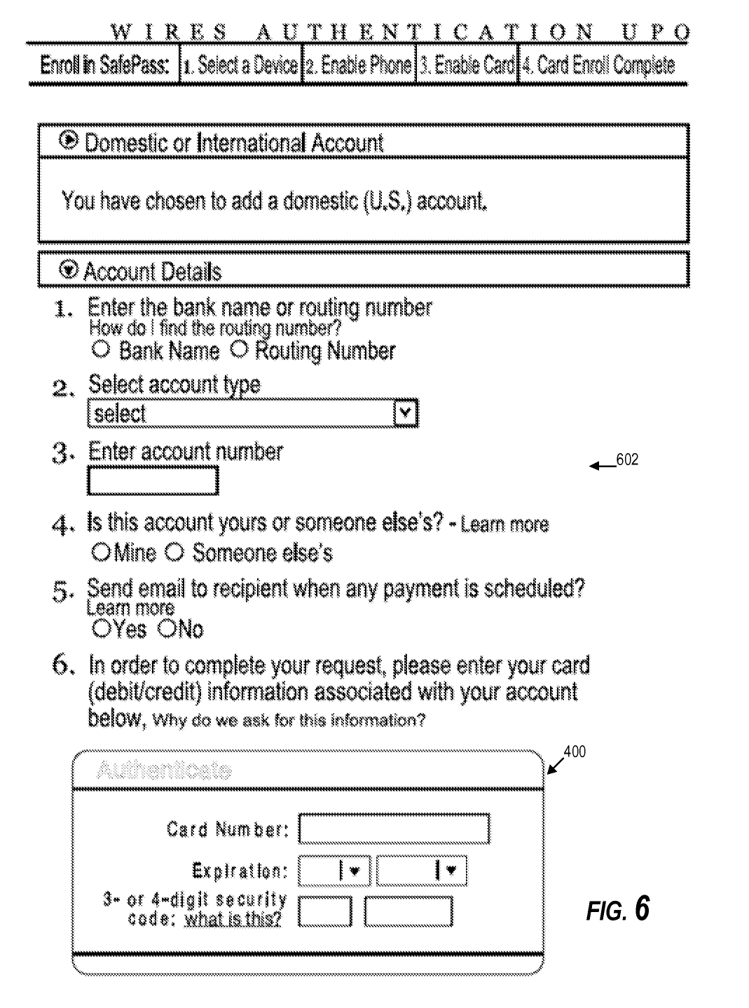

The action interface 602 of FIG. 6 illustrates the action selected by the user being adding/connecting an account (whether internal or external of the user's bank) with the user's account. The action interface 602 includes the text and input fields presented above the authentication tool 602 and prompts the user for transactional data that includes the bank name or routing number (as selected by the user), the account type, the account number, whether the account is the user's or someone else's, whether to send an email to the recipient, and when a payment is scheduled. Other transactional data about setting and up and managing the account may also be prompted for the user to input.

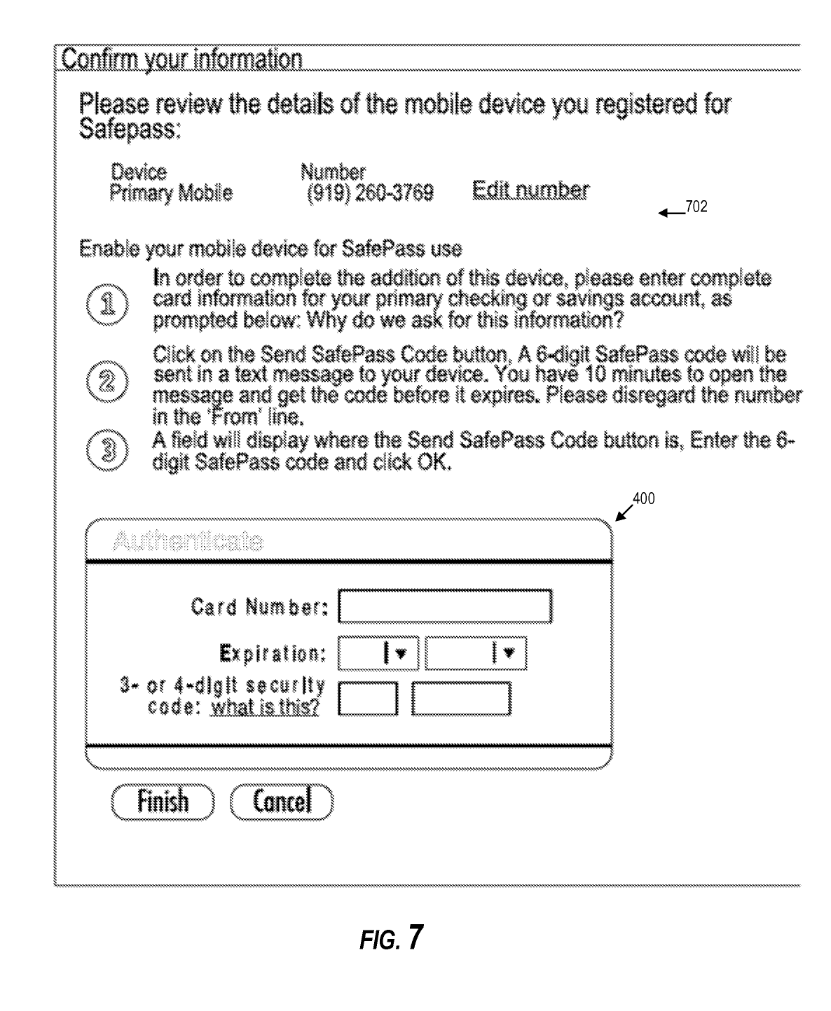

The action interface 702 of FIG. 7 illustrates the action selected by the user being enrolling in an authentication program, such as an authentication program called SAFEPASS®. The action interface 702 includes the text presented above the authentication tool 702 and provides the user with information that the user has initiated registration/enrollment of the mobile device in the authentication program. The action interface 702 also provides information about how to complete the registration/enrollment of the mobile device. As illustrated, the authentication tool 400 is presented to the user to verify the identity of the user.

It should be noted that the authentication tool may be a part of the action interface or may be a separate tool that is presented along with the action interface.

Referring back to FIG. 2, the user enters input in the action interface in the form of transaction data regarding the electronic funds transfer (or other selected online action) at block 206. In block 208, the user also inputs the required authentication data 209 (e.g., credit/debit card number, CVV, credit/debit card expiration number, etc.) into the authentication tool 400 as prompted by the authentication tool 400.

In block 210, after the user inputs the transaction data into the action interface and authentication data 209 in the authentication tool, the authentication data 209 is transferred/stored to the security server 128 (or the banking server 102) at the bank 130 and/or optionally to a server at a third party vender. The authentication data 209 is then compared with the data (stored credit/debit card information) stored in memory at the security sever to determine if the authentication data 209 is valid.

It should be noted that the credit/debit card information is used in the present invention only for authenticating an identity of the user, according to one embodiment. The present invention does not use the credit/debit card information to perform a credit/debit transaction with the user's credit/debit account. Thus, the credit/debit card information is used to verify that the credit/debit card credentials supplied to the bank are indeed valid or accurate without using the crediting/debiting feature of the credit/debit card (i.e., using the user's credit/debit card for crediting and/or debiting funds from the user's checking/saving account or a revolving credit facility).

In block 212, a determination is made as to whether the authentication data 209 is valid. If not, the user is not allowed to perform the selected online action and an error message is displayed in block 214; then, the method 200 may continue back to block 204 where the user can re-enter the information to retry being authenticated.

If the authentication data 209 is determined to be valid, the method 200 continues to block 216 where the identity of the user is authenticated and, in response to the user being authenticated, the user is allowed to proceed with the selected action or the selected action is completed (e.g., the electronic funds transfer succeeds, the account is added, the wire is initiated, a new account is established, etc.).

FIG. 3 illustrates some alternative embodiments of an authentication procedure 300 in accordance with the present invention. Generally, these embodiments allow for alternate or additional authentication procedures to occur based on whether a user is enrolled in an authentication program with the user's bank or third party. Some of the steps of the method 300 of FIG. 3 are similar to some of the steps of the method 200 of FIG. 2.

In block 301, a user logs into the online system using the user's credentials, such as an online system 117, an ATM, a bank terminal, etc. as previously mentioned. If authenticated to the online system, the user is allowed to select one or more actions to perform at block 302, as previously discussed with regard to block 202 of FIG. 2. In response to the user selecting an action to perform an action interface (similar to those described above with respect to FIG. 2) is presented to the user to set up, initiate, and/or complete the selected action.

As discussed above, the user can be enrolled in an authentication program at the bank. This authentication program may be a voluntary program that the user signs up for in an effort to add additional security measures to her banking account. This authentication can be any method to verify the identity of the user. As used hereforward, this authentication program may be a program called SAFEPASS®. SAFEPASS® is an additional authentication procedure that may be used to authorize certain high-risk transactions when using an online banking system, such as, for example, transactions over a predetermined dollar amount. SAFEPASS® uses an authentication tool that is different and separate from the authentication tool 400 discussed above and illustrated with respect to FIGS. 2 and 4-7. The SAFEPASS® authentication tool was previously discussed in U.S. patent application Ser. No. 12/348,376 filed on Jan. 5, 2009, which is incorporated herein in its entirety.

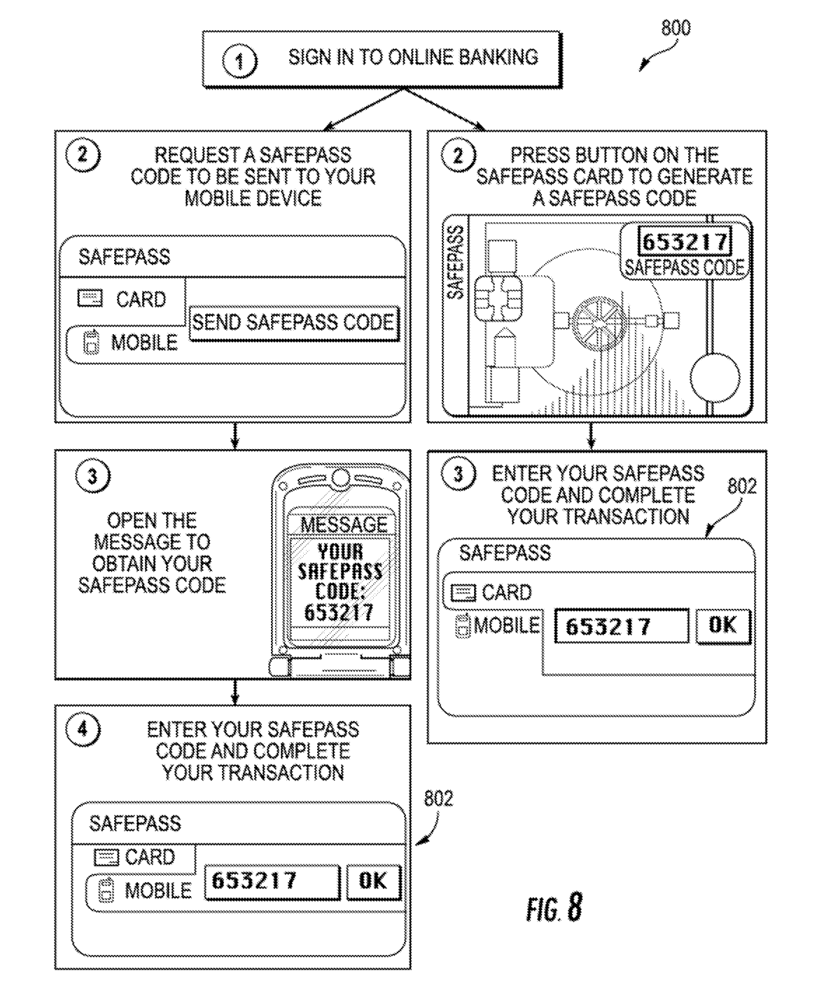

The authentication process 800 and authentication tool 802 of SAFEPASS® is illustrated generally in FIG. 8 according to some embodiments. In SAFEPASS®, an authentication tool 802 is provided to the user if the user is enrolled in SAFEPASS® and in response to the user selecting an action that requires a verification of the identity of the user. The user is provided with a security code that may be used to authenticate an electronic funds transfer. The security code may also be referred to as a one-time passcode that is randomly generated when requested, and it expires after a predetermined period of time. The security code may be provided electronically when a user clicks a button on her computer to send a SAFEPASS® code via a text message (e.g., SMS or MMS message) to the user's mobile phone. The user may also obtain a SAFEPASS® code by pressing a button on a SAFEPASS® card that will display a new code in a window on the card each time the button is pressed. Numerous methods may be used to electronically send a security code to a user; therefore, the present invention is not limited to the specific embodiments of electronically providing a security code to the user as described herein. Regardless, the user then enters the SAFEPASS® code, and if the SAFEPASS® code is valid the user is authenticated to perform a selected task. If the SAFEPASS® code is not valid, the process 800 may be terminated.

Referring back to FIG. 3, in block 306, a determination is made as to whether the user is enrolled in the special authentication program such as SAFEPASS®. If not, the method continues to block 308 where the user is presented with the credit/card authentication tool 400, as previously discussed with regard to FIGS. 2 and 4-7. However, if the user is enrolled in the special authentication program such as SAFEPASS®, a special authentication tool (such as the SAFEPASS® authentication tool 802 illustrated in FIG. 8) is presented to the enrolled user at block 307.

In block 310, the user enters the required transaction data into the action interface for setting up, initiating, and/or completing an action in the online system. As previously mentioned, in the example of the action being an electronic funds transfer used herein, the transaction data may include, among other things, information regarding the source account, destination account, account holder(s), amount of funds to be transferred, the date upon which the funds are to be transferred from the source account to the destination account, and any other information that may be input for an electronic funds transfer. Additionally, the action interface of FIG. 3 is substantially similar or the same as the action interface of FIG. 2 and changes based on whatever action is selected to be performed by the user.

In block 312, the user enters the authentication data into the authentication data 309 into the credit/card authentication tool and/or the special enrollment program authentication tool so that the identity of the user can be authenticated.

In block 314, the authentication data 309 is then transferred to the bank 130 to the security server 128 (or another server at the bank or at a third party). The authentication data 309 relates to the data entered into one or more of the authentication tools 400 and/or 802. Additionally, in block 314, the authentication data 309 is compared with credit/debit card information 132 and/or other authentication data 311 (depending on which authentication tool is presented to the user) to verify if the authentication data 309 is valid. For example, if the credit/debit authentication tool 400 was presented to the user, the authentication data 309 includes the credit/debit card information entered into the credit/debit authentication tool by the user and such credit/debit card information is compared with credit/debit card information previously stored at the server 128 of the bank 130. If the special authentication tool 802 of the authentication program that the user is enrolled in was presented to the user, the authentication data 309 includes other authentication data, such as the electronically transmitted passcode, and is compared with a authentication data 311 (e.g., a stored passcode) at the server. 128 of the bank 130. If the comparison is valid, then the user's identity is validated.

In block 316, a determination is made as to whether the authentication data 309 is valid. If not, the user is not allowed to perform the selected online action and an error message is displayed in block 318; then, the method 300 may continue back to block 310 where the user can re-enter the information to retry being authenticated.

If the authentication data 309 is determined to be valid, the method 300 continues to block 320 where the identity of the user is authenticated and, in response to the user being authenticated, the user is allowed to proceed with the selected action or the selected action is completed (e.g., the electronic funds transfer succeeds, the account is added, the wire is initiated, a new account is established, etc.).

Alerts are an additional security feature that may be utilized by a bank to notify customers of potential fraudulent activity. Alerts are convenient and easy to use. They provide timely notifications to customers on critical transactions, and they send reports to the customer when the customer's information or credentials have changed. Customers who respond to alerts are “first responders” to suspicious activity that notifies the bank when a potential fraud has occurred or the bank's system may have been compromised. An alert is sent to the owner of the source account (and anyone else) if fraudulent activity has been detected. Also, an alert is sent to the owner's bank to notify the bank of such activity.

Note that the present invention is not limited to the embodiment of the funds transfer and authentication process described above. The exact process may vary depending on the computer system and/or network that is used. As one of ordinary skill in the financial and computing arts would quickly recognize, the steps described above for the funds transfer and authentication process may vary, be ordered differently, or involve additional steps not disclosed herein, and that the present invention is not limited to the above process.

The terminology used herein is for the purpose of describing particular embodiments only and is not intended to be limiting of the invention, unless the context clearly indicates otherwise. As used herein, the singular forms “a”, “an” and “the” are intended to include the plural forms as well, unless the context clearly indicates otherwise. It will be further understood that the terms “comprises,” “includes,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function. In one embodiment, a processor is a microprocessor that includes electrical hardware components.

It should be understood that terms like “lending institution,” “borrower,” “servicer,” “investor,” “financial institution,” “bank” and even just “institution” or “entity” are used herein in their broadest sense. Institutions, organizations, or even individuals that process loans are widely varied in their organization and structure. Terms like financial institution are intended to encompass all such possibilities, including but not limited to, banks, finance companies, brokerages, credit unions, mortgage companies, insurance companies, entities who grant loans to secure the purchase of property, any combinations thereof, a third party entity separate from any of the above, and/or the like. Additionally, disclosed embodiments may suggest or illustrate the use of agencies or contractors external to the institution to perform some or all of the method steps disclosed herein. These illustrations are examples only, and an institution or business can implement the entire invention on their own computer systems or even a single work station if appropriate databases are present and can be accessed.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

We claim:

1. A method of authenticating a user of an online system at a financial institution to an electronic funds transfer, the method comprising:
receiving logon credentials of the user to an online banking system of a financial institution where the user has an account;
authenticating the user to the online banking system;
receiving a selection that the user desires to perform an electronic funds transfer using the user's account;
presenting an authentication tool configured to allow a user to enter information associated with a credit/debit card associated with the user's account at the financial institution to determine if the user is authorized to perform the electronic funds transfer;
receiving credit card information entered by the user into the authentication tool;
validating, using a computer, an identification of the user using the received credit card information; and
authenticating the user in response to the identification of the user being valid.

2. The method of claim 1 wherein the credit card information that the user enters comprises:
a credit/debit card number identifying the user's account; and
an expiration date of the credit/debit card.

3. The method of claim 2, wherein the credit card information that the user enters further comprises a card verification value (“CVV”) of the credit/debit card

4. The method of claim 3 wherein the CVV comprises one of a three or four digit security code located on the back of a credit/debit card.

5. The method of claim 1 wherein the credit/debit card information is only used to authenticate the user and the credit card is not used to credit or debit the user's account.

6. The method of claim 1 further comprising presenting an interface for entering information needed to perform the online banking action.

7. The method of claim 6 wherein the interface is presented along with the authentication tool on a single graphical user interface.

8. The method of claim 1 wherein the electronic funds transfer comprises one of an automated clearing house (“ACH”) transfer or an electronic wiring of funds.

9. The method of claim 1 wherein the validating the identification of the user comprises:
sending the received credit card information to a security server;
comparing the received credit card information to stored credit card information stored at the security server; and
providing an indication that the received credit card information is valid in response to determining that the received credit card information matches the stored credit card information.

10. The method of claim 1 further comprising disallowing the user to perform the electronic funds transfer in response to the received credit card information not being validated.

11. The method of claim 1, further comprising sending an alert in response to determining unauthorized access to the user's account.

12. The method of claim 1 further comprising:
receiving an indication that the user desires to add an account to be used in electronic funds transfer;
receiving account information required to add the account; and
adding the account in response to the user being authenticated.

13. The method of claim 1 further comprising:
validating transaction data related to the electronic funds transfer; and
validating the electronic funds transfer.

14. The method of claim 1 wherein the user is using a computer system to request access to a remotely located device through a web-based interface.

15. The method of claim 1 further comprising:
determining if the user is enrolled in an authentication program, whereby the authentication program comprises an online authentication tool that is only presented to the user if the user is enrolled in the authentication program and in response to the user attempting to perform an action in an online banking system; and
presenting the online authentication tool in response to determining that the user is enrolled in the authentication program.

16. The method of claim 15 wherein the online authentication tool comprises a tool that uses a security code that is provided to the user electronically to authenticate the electronic funds transfer.

17. A method of authenticating an action in an online banking system, the method comprising:
receiving logon credentials of a user to the online banking system of a financial institution where the user has an account;
authenticating the user to the online banking system;
receiving a selection of an action that the user desires to perform in the online banking system;
presenting an authentication tool configured to allow a user to enter credit card information of a credit/debit card associated with the user's account to determine if the user is authorized to perform the selected action;
receiving credit card information entered by the user into the authentication tool; and
authenticating, using a computer, the user in response to the received credit card information being validated.

18. The method of claim 17 wherein the credit card information that the user enters comprises:
a credit/debit card number identifying the user's account;
an expiration date of the credit/debit card; and
a card verification value (“CVV”) of the credit/debit card.

19. The method of claim 18 wherein the CVV comprises one of a three or four digit security code located on the back of a credit/debit card.

20. The method of claim 18 wherein the credit card information is only used to validate an identity of the user.

21. The method of claim 17 further comprising presenting an interface for entering information needed to perform the online banking action.

22. The method of claim 21 wherein the interface is presented along with the authentication tool on a single graphical user interface.

23. The method of claim 17 wherein the action comprises an action associated with an electronic funds transfer.

24. A non-transitory computer-readable medium having computer program code embodied thereon, the computer program code, when executed on a computing device, configured to perform a method for authenticating an action via an online banking system, the method comprising:
receiving logon credentials of a user to the online banking system of a financial institution where the user has an account;
authenticating the user to the online banking system;
receiving a selection of an action that the user desires to perform in the online banking system;
presenting an authentication tool configured to allow a user to enter credit card information of a credit/debit card associated with the user's account to determine if the user is authorized to perform the selected action;
receiving credit card information entered by the user into the authentication tool; and
authenticating the user in response to the received credit card information being validated.

25. The non-transitory computer-readable medium of claim 24 wherein the credit card information that the user enters comprises:
a credit/debit card number identifying the user's account;
an expiration date of the credit/debit card; and
a card verification value (“CVV”) of the credit/debit card.

26. The non-transitory computer-readable medium of claim 24 further comprising presenting an interface for entering information needed to perform the online banking action, wherein the interface is presented along with the authentication tool on a single graphical user interface.

27. The non-transitory computer-readable medium of claim 24 further comprising validating, using a computer, an identification of the user using the received credit card information comprising:
sending the received credit card information to a security server;
comparing the received credit card information to stored credit card information stored at the security server; and
providing an indication that the received credit card information is valid in response to determining that the received credit card information matches the stored credit card information.

28. The method of claim 24 wherein the action comprises an action associated with an electronic funds transfer.

29. An apparatus for authenticating an action via an online system, the apparatus comprising:
an input system configured to allow a user to log into the online system and initiate the action via the online system; and
a processing system in communication with the input system and configured to:
receive credit card information entered by the user into the authentication tool; and
authenticate the user in response to the received credit card information being validated.

30. The apparatus of claim 29 wherein the authentication tool is configured to allow a user to enter credit card information of a credit/debit card associated with the user's account to determine if the user is authorized to perform the selected action.

31. The apparatus of claim 30 wherein the credit card information that the user enters comprises:
a credit/debit card number identifying the user's account;
an expiration date of the credit/debit card; and
a card verification value (“CVV”) of the credit/debit card.

32. The apparatus of claim 29 wherein the processing system comprises a server configured to:
receive logon credentials of a user to the online banking system of a financial institution;
authenticate the user to the online banking system;
receive a selection of an action that the user desires to perform in the online banking system;
compare the received credit card information to stored credit card information stored at the server; and
provide an indication that the received credit card information is valid in response to determining that the received credit card information matches the stored credit card information.

33. A method of authenticating an action in an online banking system, the method comprising:
receiving logon credentials of a user to the online banking system of a financial institution where the user has an account;
authenticating the user to the online banking system;
receiving a selection of an action that the user desires to perform in the online banking system;
determining if the user is enrolled in an authentication program, whereby the authentication program comprises a first authentication tool in response to the user attempting to perform an action in an online banking system;
in response to determining that the user is enrolled in the authentication program, presenting the first authentication tool;
in response to determining that the user is not enrolled in the authentication program presenting a second authentication tool that is different from the first authentication tool, wherein the second authentication tool is configured to allow a user to enter credit card information of a credit/debit card associated with the user's account to determine if the user is authorized to perform the selected action;
determining, using a computer, if the user is authenticated using input received in the first authentication tool or the second authentication tool.

34. The method of claim 33 wherein the credit card information that the user enters comprises:
a credit/debit card number identifying the user's account;
an expiration date of the credit/debit card; and
a card verification value (“CVV”) of the credit/debit card.

35. The method of claim 33 further comprising receiving credit card information entered by the user into the authentication tool in response to presenting the second authentication tool.

36. The method of claim 33 wherein in response to determining that the user is not enrolled in the authentication program the second authentication tool is presented instead of the first authentication tool.

37. The method of claim 33 wherein the first authentication tool presents electronically a security code to one of the user's phone or card for inputting in the first authentication tool.

38. An apparatus for authenticating an action via an online system, the apparatus comprising:
an input system configured to allow a user to log into the online system and initiate the action via the online system; and
a processing system in communication with the input system and configured to:
determine if the user is enrolled in an authentication program;
in response to the user attempting to perform an action in an online banking system:
present a first authentication tool in response to determining that the user is enrolled in the authentication program; and
present a second authentication tool that is different from the first authentication tool in response to determining that the user is not enrolled in the authentication program, wherein the second authentication tool is configured to allow a user to enter credit card information of a credit/debit card associated with the user's account to determine if the user is authorized to perform the selected action; and
determine if the user is authenticated the user using input received in the first authentication tool or the second authentication tool; and
allow the user to perform the action in response to the user being authenticated.

39. The apparatus of claim 38, wherein the processing system is further configured to receive credit card information entered by the user into the authentication tool if the second authentication tool is presented.

40. The apparatus of claim 39 wherein the processing system is further configured to:
authenticate the user to the online banking system;
receive a selection of an action that the user desires to perform in the online banking system;
compare the received credit card information to stored credit card information stored at the server; and
provide an indication that the received credit card information is valid in response to determining that the received credit card information matches the stored credit card information.

41. The apparatus of claim 39 wherein the credit card information that is inputted comprises:
a credit/debit card number identifying the user's account;
an expiration date of the credit/debit card; and
a card verification value (“CVV”) of the credit/debit card.

42. The apparatus of claim 39 wherein the processing system comprises a security server configured to:
receive the received credit card information;
compare the received credit card information to stored credit card information stored at the security server; and
provide an indication that the received credit card information is valid in response to determining that the received credit card information matches the stored credit card information.

43. The apparatus of claim 38 wherein the second authentication tool is presented in an interface that also includes details input about the action that the user wishes to perform.

44. The apparatus of claim 43 wherein the action comprises an electronic funds transfer and the details included in the interface includes the information required to set up an electronic funds transfer.
